(19) United States
(12) Patent Application Publication
(10) Pub. No.: US 2007/0053578 A1
(43) Pub. Date: Mar. 8, 2007

(54) Pattern inspection apparatus and method and reticle for use therein

(75) Inventor: Nobuyuki Harabe, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Advanced Mask Inspection Technology Inc, Kawasaki-shi (JP)

(21) Appl. No.: 11/304,664

(22) Filed: Dec. 16, 2005

(30) Foreign Application Priority Data
Sep. 7, 2005 (JP) 2005-259162

(51) Int. Cl. G06K 9/00

(52) U.S. Cl. 382/145

(57) ABSTRACT

A method and apparatus for performing appropriate inspection by selecting a pattern comparison technique in accordance with the pattern feature of an object being tested are disclosed. The pattern inspection apparatus includes an optical image acquisition unit which acquires an optical image of the test object. A plurality of types of feature comparator units are provided for comparing identical patterns at different positions on the test object based on feature data indicating pattern features of the test object. During comparison of the identical patterns of the optical image, a selector unit selects an adequate kind of feature comparator from the pattern feature data of the test object.

### CROSS-REFERENCE TO RELATED APPLICATION

This application is based upon and claims the benefit of priority from the prior Japanese Patent Application No. 2005-259162, filed on Sep. 7, 2005, the entire contents of which are incorporated herein by reference.

### BACKGROUND OF THE INVENTION

1. Field of the Invention

The present invention relates generally to pattern inspection of objects to be tested such as reticles, and more particularly to a method and apparatus for pattern inspection of an object being tested for use in the manufacture of semiconductor devices and liquid crystal display panels or the like. This invention also relates to reticles as pattern-inspected thereby.

2. Description of the Related Art

In large-scale integrated (LSI) circuit fabrication processes, optical reduction exposure equipment (stepper) for the circuit pattern transfer use is typically designed to employ as its original or master plate a reticle (photomask) with a circuit pattern being formed and magnified by a degree of four to five times. Completeness requirements for this reticle—that is, demands for pattern accuracy, zero defects, shorter inspection time periods and others—are becoming higher year by year. In recent years, the quest for ultra-fine fabrication and higher integration results in the pattern transfer being performed at levels in close proximity to the resolution limit of the stepper. This causes high-accuracy reticles to be the key focus in semiconductor device microfabrication processes. In particular, it is inevitable to enhance the performance of pattern inspection apparatus operative to detect defects of ultrafine patterns. Enhancing the pattern inspection apparatus performance is a must to shorten development periods of highly advanced or “leading-edge” semiconductor devices while improving production yields thereof. In this regard, a known technique for performing pattern inspection by setting up the test precision in units of reticle patterns is disclosed, for example, in JP-A-2004-191957.

### BRIEF SUMMARY OF THE INVENTION

It is therefore an object of the present invention to provide an approach to performing appropriate inspection by selecting a pattern comparison technique in conformity with the pattern feature of an object to be tested.

Alternatively, it is an object of this invention to effectively perform pattern inspection by selecting a pattern comparison technique in a way pursuant to the pattern feature of an object being tested.

An alternative object of the invention is to shorten a pattern inspection time period by selecting a pattern comparison scheme in accordance with the pattern feature of an object under test.

An alternative object of the invention lies in providing pattern inspection apparatus and methodology capable of offering enhanced performances by selecting a pattern comparison scheme in accordance with the pattern feature of a test object or, alternatively, to obtain a reticle adaptable for use therein.

In accordance with a first aspect of the invention, a pattern inspection apparatus is provided, which includes an optical image acquisition unit that operates to obtain an optical image of an object being tested, a plurality of types of feature comparison units each of which compares, based on feature data indicative of pattern features of the optical image of the test object, identical patterns at different positions on the test object, and a selector unit which selects, during comparison of the identical patterns of the optical image, a kind of feature comparison unit from the feature data of a pattern under inspection.

In accordance with a second aspect of the invention, a pattern inspection apparatus includes an optical image acquisition unit which operates to obtain an optical image of an object being tested, a reference image creation unit which makes a reference image from pattern design data of the test object, a plurality of types of feature comparison units operable to compare, based on feature data indicative of pattern features of the test object, the optical image to the reference image, and a selector unit which selects, when comparing between the optical image and the reference image, a kind of feature comparison unit from the feature data of a pattern to be inspected.

In accordance with a third aspect of the invention, a pattern inspection method is provided, which includes an optical image acquisition step of obtaining an optical image of an object being tested, a plurality of kinds of feature comparison steps of comparing, based on feature data indicative of pattern features of the test object, identical patterns at different positions on the test object, and a selection step of selecting, when comparing an optical image and a reference image, a feature comparison step from the feature data of a pattern under inspection.

In accordance with a fourth aspect of the invention, a pattern inspection method includes an optical image acquisition step of acquiring an optical image of an object being tested, a reference image creation step of making a reference image from design data of a pattern of the test object, a plurality of kinds of feature comparison steps of comparing, based on feature data indicative of pattern features of the test object, the optical image to the reference image, and a selection step of selecting, when comparing the optical image to the reference image, a feature comparison step from the feature data of a pattern under inspection.

In accordance with a fifth aspect of the invention, a reticle is provided, which is subjected to pattern inspection by common optical image comparison with respect to identical patterns at different position on the reticle. Furthermore, the reticle is pattern-inspected by a plurality of kinds of optical image feature comparisons as applied to the reticle based on the feature data indicative of reticle pattern features concerning identical patterns at different positions on the reticle.

In accordance with a sixth aspect of the invention, a reticle is provided, which is subjected to pattern inspection by common comparison of an optical image of the reticle to a reference image. The reticle is also applied further pattern inspection by means of a plurality of kinds of feature comparisons of optical and reference images based on feature data indicative of reticle pattern features.

These and other objects, features and advantages of the invention will be apparent from the following more particular description of preferred embodiments of the invention, as illustrated in the accompanying drawings.

### BRIEF DESCRIPTION OF THE SEVERAL VIEWS OF THE DRAWINGS

FIG. 1 is a block diagram showing a configuration of a pattern inspection apparatus embodying the invention.

FIG. 2 is a diagram depicting a detailed configuration of main part of the pattern inspection apparatus.

FIG. 3 is a perspective view of a reticle with its pattern being scanned.

FIG. 4 is a flow diagram of a reticle pattern inspection method.

FIG. 5A is a photographic representation of an exemplary pattern of a reticle, and FIG. 5B is a diagram for explanation of feature data of the reticle.

FIG. 6A is a photograph of exemplary pattern line widths, and FIG. 6B is a graph showing a pattern linewidth curve for explanation of a pattern linewidth comparison scheme.

FIG. 7A is a photograph of exemplary adjacent patterns, and FIG. 7B is a graph for explanation of a feature comparison scheme of relative positions of the adjacent patterns.

FIG. 8A is a photograph of exemplary pattern edges, and

FIG. 8B is a graph for explanation of a feature comparison scheme of the roughness of such pattern edges.

FIG. 9A is a photograph of an exemplary reticle pattern having holes, and FIG. 9B is a diagram for explanation of feature data thereof.

FIG. 10A is a photograph of a reticle pattern with holes, and FIG. 10B is a diagram for explanation of a feature comparison scheme of amounts of hole-transmitted light rays.

### DETAILED DESCRIPTION OF THE INVENTION

An explanation will now be given of the pattern inspection of an object being tested, such as a reticle, in accordance with a currently preferred embodiment of this invention.

(Pattern Inspection Apparatus)

A pattern inspection apparatus is the one that inspects an object under test, such as a reticle, to determine whether a pattern formed thereon has a prespecified shape in an expected manner. The pattern inspection apparatus includes an optical image acquisition unit, which functions to scan a pattern that is drawn on the test object to thereby obtain the data of an optical image, and then compare data of identical patterns at different locations of this test object to thereby inspect the test object to verify whether its pattern is formed into a prespecified shape (die-to-die inspection). The test object has a pattern which is to be transferred or “imaged” onto substrates, such as for example semiconductor wafers or liquid crystal (LC) base plates.

Alternatively, the pattern inspection apparatus is operable to scan a pattern drawn on a test object to obtain the data of an optical image at the optical image acquisition unit and also processes, at a reference image creation unit of a data processing unit, design data which becomes the “source” of a pattern image for depiction onto the test object, thereby obtaining reference image data. The pattern inspection apparatus operates to compare the optical image data to the reference image data at a comparator unit and performs inspection to determine whether the test object's pattern is formed to have an expected shape (die-to-database inspection). The design data is a “base” used for pattern depiction on the test object. It should be noted here that although the explanation below assumes that the test object is a reticle, this test object may be any ones with a circuit pattern formed thereon, including a photomask, wafer and equivalents thereto.

The comparator unit includes a plurality of feature comparator modules with different functionalities. Each feature comparator is for performing pattern comparison based on the pattern feature of either the reticle's optical image or the reference image. These feature comparators are provided in units of patterns. Selection of a feature comparator of the test object pattern is carried out while referring to feature data, which is in use during pattern comparison at the feature comparator.

The feature data used here is the one that designates a specific pattern of reticle image and indicates a feature portion(s) of the reticle image. The feature data is created, for example, at the stage of designing the reticle image in such a manner as to correspond to reticle pattern positions, and thus is pattern identification data for pattern designation. The feature data may be designed to indicate characteristic portions of the reticle image. The feature data can be represented by an image in a way corresponding to the reticle image, for example. The feature data indicates, for example, a pattern linewidth, an amount of pattern-transmitted light, a pattern edge roughness, or a relative position(s) near or around the pattern. Note that the pattern as used in the illustrative embodiment may have any shape as far as it is mutually comparable—for example, an independent pattern, a combination of more than two independent patterns, a pattern of a portion (one part) of independent pattern, or a pattern of a portion (part) of those patterns coupled together. The comparator is equipped with a common comparator unit when the need arises. The common comparator is operable to perform image comparison without having to refer to the feature data. The common comparator has a comparison means for common use to all patterns between images.

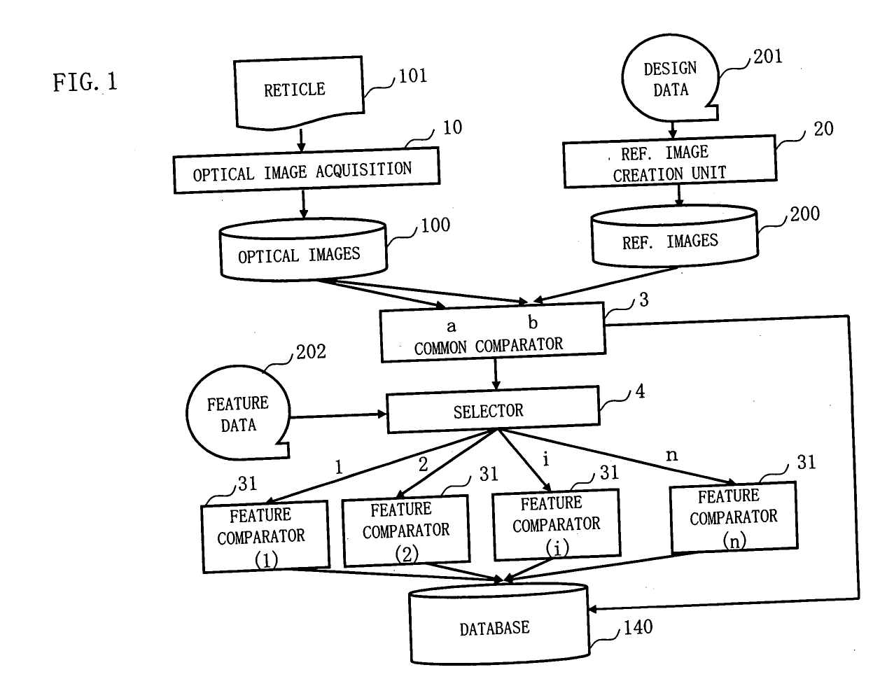

As shown in FIG. 1, for example, the pattern inspection apparatus acquires at its optical image acquisition unit 10 an optical image 100 from a reticle 101 under inspection. In the optical image 100 thus obtained, data (input data at nodes “a” and “b”) of identical pattern components at different locations of the reticle are subjected to comparison at a common comparator unit 3 (die-die inspection). Alternatively, acquire at the optical image acquisition unit 10 an optical image 100 from the reticle 101 being tested and then prepare at a reference image creation unit 20 a reference image 200 from the reticle's design data 201. Pattern data of the optical image 100 and reference image 200 thus obtained (i.e., input data at the nodes a and b) are compared together at the common comparator 3 (die-database inspection).

The pattern inspection apparatus compares images at the common comparator 3. The common comparator 3 compares the optical image 100 to the reference image 200 in accordance with an adequate algorithm to thereby determine or “judge” whether pattern defects are present or absent. One example is that the pattern inspection apparatus compares the optical image 100 to reference image 200 and then identifies whether a difference therebetween exceeds a predefined threshold to thereby judge the presence or absence of defects. When more than one defect is found, let the data of such defect be stored in a database 140. If no defects are found then perform image comparison in accordance with the feature of the pattern being tested. To do this, the pattern inspection apparatus has a plurality of feature comparator units 1, 2, . . . , i, . . . , n in a way pursuant to the pattern feature. To indicate the feature of reticle image, the pattern inspection apparatus has a collection of feature data 202 corresponding to the reticle's positions. Upon comparison between optical images or comparison of an optical image to reference image, refer to the feature data 202 for allowing a comparison means selector unit 4 to select one from among the feature comparators 1-n. Whereby, it is possible to perform the intended image comparison in accordance with the feature of an image pattern under test. The results of such image comparison, which include the contents of reticle pattern errors and positions of such errors or else, are stored in the database 140. Those patterns to be designated by the feature data typically include a pattern with its comparison accuracy increasing in compliance with the pattern feature, and a pattern that requires accurate comparison. A means for comparing a pattern that is designated by the feature data is arranged, for example, to measure for comparison the linewidth of a pattern, measure for comparison the amount of light that passed through the pattern, measure for comparison the pattern edge roughness, or measure for comparison a relative position near or around the pattern. Whether the image of interest is good or bad is determinable by using the comparison result to determine whether the value of its difference is above the threshold. Providing this type of feature comparator unit makes it possible to achieve accurate pattern inspection in conformity with the pattern feature. It is also possible to shorten a pattern inspection time as a whole, since the testing time is assignable to necessary patterns only while precluding the test time for immaterial patterns.

Although in FIG. 1 the common comparator 3 is laid out at the pre-stage of the comparison means selector unit 4 while the feature comparators 31 are disposed at the post-stage of it, the common comparator 3 and feature comparators 31 are configurable to have various combinations. An example is that the common comparator 3 is placed at the post-stage of the comparison means selector 4 whereas the common comparator 3 and feature comparators 31 are combined together to perform image comparison. Another example is that the common comparator 3 and feature comparators 31 are connected in series while letting these series-connected comparators and the sole common comparator 3 be disposed in parallel. In case the common comparator 3 and feature comparators 31 are serially interconnected, image comparison is sequentially performed at the common comparator 3 and then at feature comparator(s) 31. In such case, the comparison means selector 4 is expected to select the serially connected comparators and the sole or “stand-alone” common comparator 3. Alternatively, the common comparator 3 may be placed at the post-stage of comparison means selector 4 while letting common comparator 3 and feature comparators 31 be connected in parallel. In this case, the comparison means selector 4 is expected to select the common comparator 3 and feature comparator(s) 31.

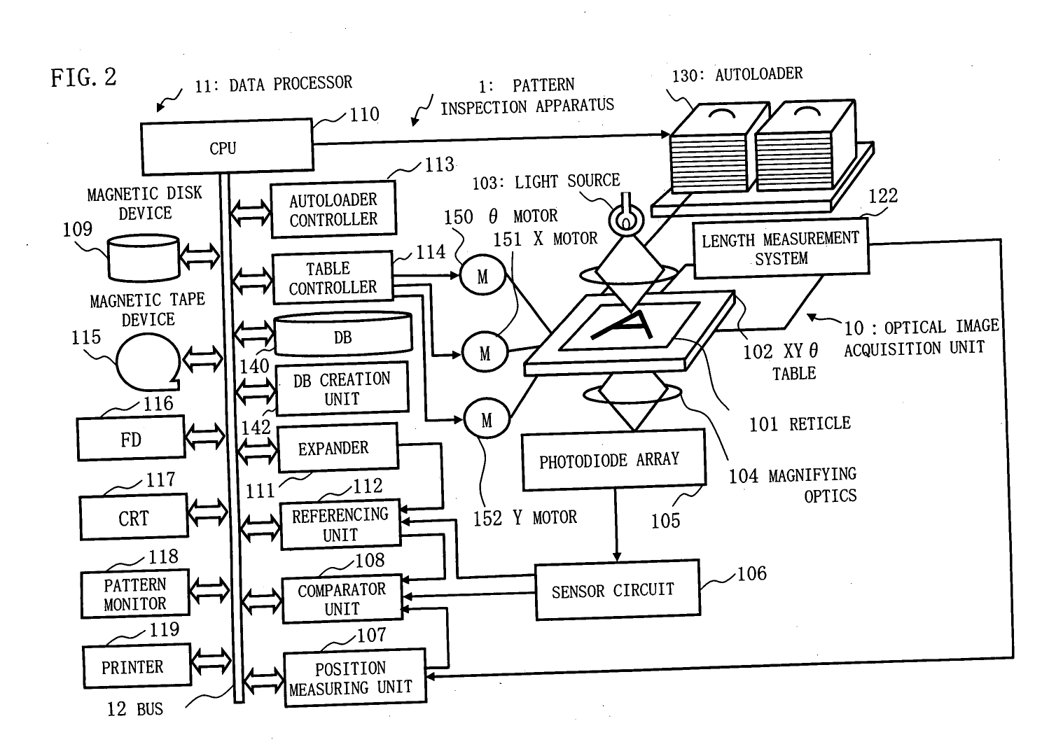

As shown in FIG. 2 for example, the pattern inspection apparatus 1 includes the optical image acquisition unit 10 and a data processing unit 110. The optical image acquisition unit 10 is typically arranged to have an automatic loader 130, a light source 103, an X-Y-θ table 102 for mounting thereon a reticle 101, a θ motor 150, an X-axis motor 151, a Y-axis motor 152, a laser-assisted length measurement system 122, a magnification lens assembly 104, a photodiode (PD) array 105, a sensor circuit 106 and others, as circumstances demand. Where necessary, the data processor unit 11 includes, but not limited to, a central processing unit (CPU) 110, a data transfer bus 12, an auto-loader controller 113 that is connected to the bus 12 for control of the auto-loader 130, a table controller 114 for control of the XYθ table 102, a database 140, a database creation unit 142, an expander 111, a referencing unit 121 for receipt of pattern data of the design data from the expander 111, a comparator 108 which receives an optical image from the sensor circuit 106 while receiving a reference image from the referencing unit 121, a position measurement unit 107 for receiving from the laser-assisted length measurement system 122 a position signal of the table 102, a magnetic disk device 109, a magnetic tape device 115, a floppy disk (FD) drive 116, a cathode ray tune (CRT) display 117, a pattern motor 118, and a printer 119. The reference image creation unit 20 of FIG. 1 is made up of the expander 111 and referencing unit 112 in the data processor 11. The comparator 108 is arranged to include the common comparator 3, comparison means selector 4, and feature comparators 31 shown in FIG. 1. Additionally the pattern inspection apparatus 1 is configurable from electronic circuitry, software programs or any possible combinations thereof.

(Optical Image Acquisition Unit)

The optical image acquisition unit 10 is operable to acquire the optical image of a reticle 101. The reticle 101 is for use as an object to be inspected and is mounted on the XYθ table 102. The XYθ table 102 is driven by the X-, Y- and θ-motors 151, 152, 150 to move in horizontal and rotation directions. This table 102 is motion-controlled in response to a command signal from the table controller 114. Light emitted from the light source 103 is guided to fall onto the pattern as formed on the reticle 101. Light that passed through the reticle 101 is then guided to travel through the magnification optics 104 to hit the photodiode (PD) array 105 so that a focused optical image is formed thereon. An image that was captured by the PD array 105 is processed by the sensor circuit 106 and is then photoelectrically converted into data of the sensed optical image for comparison with a reference image.

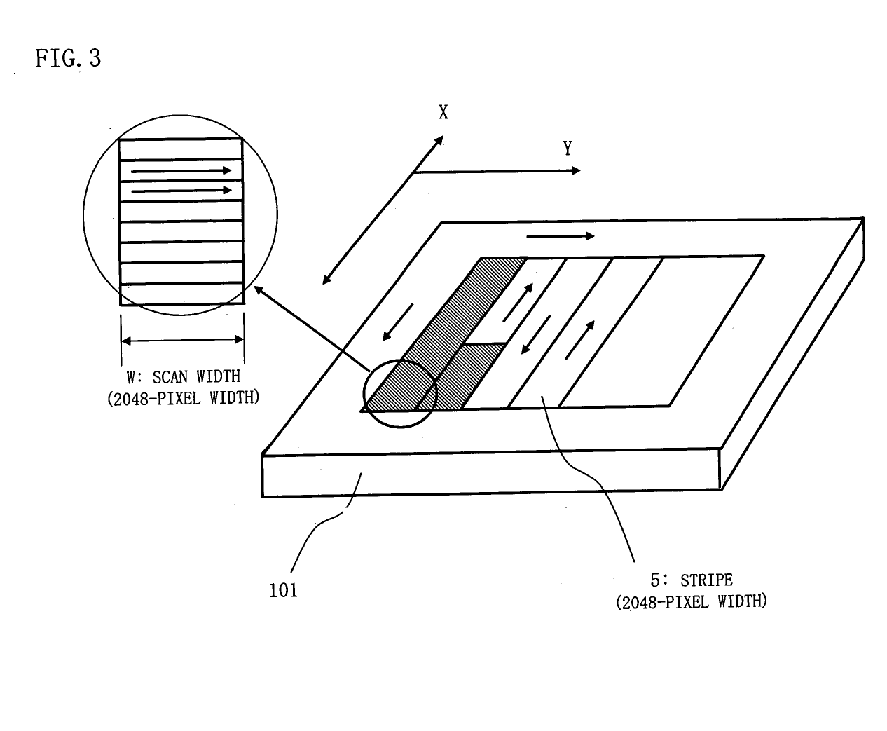

A procedure for optical image acquisition will be explained with reference to FIG. 3 below. A reticle 101 has its surface area to be inspected, which is virtually subdivided along the Y direction into a plurality of narrow, elongate portions 5 to be tested—say, test strips—as shown in FIG. 3, wherein each test strip has a scan width W. To permit respective divided test strips 5 to be scanned continuously, the XYθ table 102 is driven to move in the X direction under control of the table controller 114. In responding to the table movement, an optical image of each test stripe 5 is captured by the PD array 105. The PD array 105 captures, in succession, images each having the scan width W. After having captured the image of a first test strip 5, the PD array 105 changes to move in the opposite direction to thereby seamlessly capture by a similar method the image of a second test strip 5 with the scan width W. The image of a third test strip 5 is captured by the PD array 105 which moves in the opposite direction to that in the case of capturing the second test strip 5—that is, in the same direction as that of the image capturing of first test strip 5. In other words, the PD array 105 moves in a serpentine manner to sequentially capture the images of test strips 5 on reticle 101, without having any appreciable time lag between neighboring ones of these strips. By capturing images continuously in this way, it is possible to shorten the wasteful processing time. Note here that the scan width W is set to a value equivalent to 2,048 pixels, as an example.

The pattern image thus focused on the PD array 105 is photoelectrically converted thereby into an electrical image signal, which is then analog-to-digital (A/D) converted by the sensor circuit 106 to a corresponding digital signal. The light source 103, magnifying optics 104, PD array 105 and sensor circuit 106 make up an inspection optical system of high magnifying power.

The XYθ table 102 is driven by the table controller 114 under control of the CPU 110. A moved position of the XYθ table 102 is measured by the laser-assisted length measurement system 122 and is then sent forth toward the position measurement unit 107. The reticle 101 on the table 102 is transported from the auto-loader 130 under control of the auto-loader controller 113. Measured pattern data of each test strip 5 as output from the sensor circuit 106 is passed to the comparator unit 108 along with the data indicative of a present position of the reticle 101 on XYθ table 102 as output from the position measurement circuit 107. The data of an optical image and the reference image of an object to be compared are cut or “diced” into areas each having an appropriate pixel size—for example, 512×512 pixel regions. Although the optical image stated above is obtained using the transmitted light, similar results are attainable by use of reflected light, scattered light, polarized scatter light, polarized transmit light or equivalents thereof.

(Reference Image Creation Unit)

The reference image creation unit 20 is the one that creates a reference image. The reference image creator 20 uses the design data of a reticle under inspection to make a reference image that resembles the optical image of interest. The reference image creator 20 prepares such reference image through execution of various kinds of conversion operations with respect to the design data. The reference image creator 20 is configurable, for example in FIG. 2, from the expander unit 111 and referencing unit 112. The expander 111 reads the design data of reticle image from the magnetic tape device 115 through the CPU 110 and then converts it to image data. The referencing unit 111 receives the image data from expander 111 and then performs image processing—such as rounding corners of graphic forms, defocusing figures in certain degree or else—for causing it to resemble the optical image to thereby create the reference image required.

(Pattern Inspection Method)

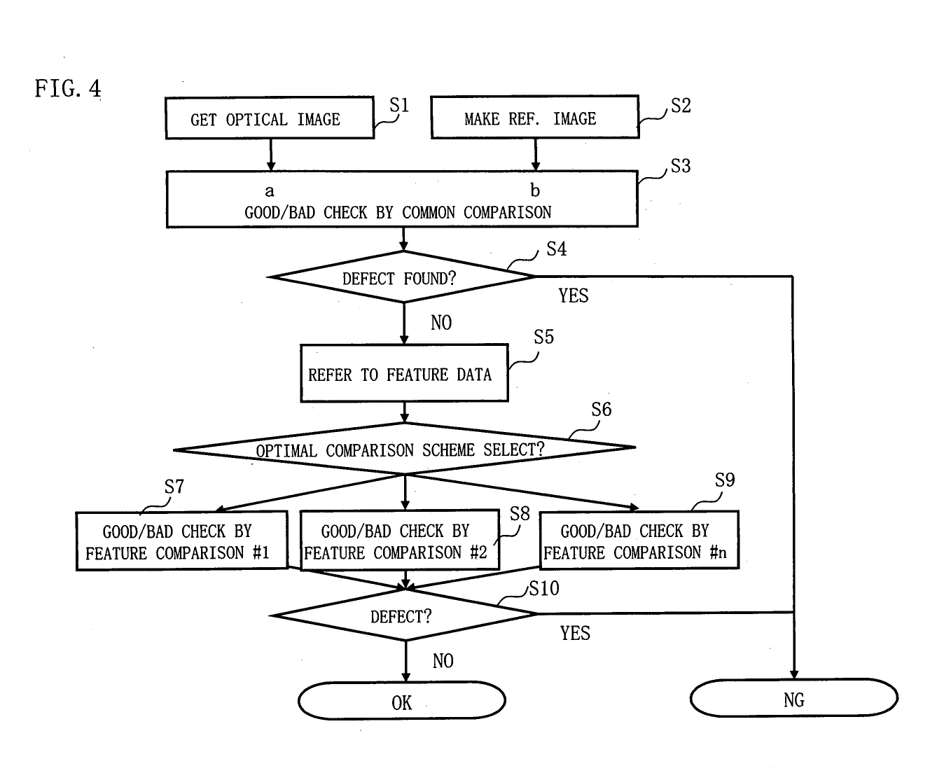

A pattern inspection method is to inspect the pattern of a reticle for defects. As shown in FIG. 4 for example, the pattern inspection method starts with an optical image acquisition step S1, which acquires an optical image from the pattern that is drawn on such reticle, followed by comparison of input data of the data a and b of identical pattern components at different locations on the reticle by use of a common comparison technique (i.e., common comparison step). By this common comparison, there are determined whether the pattern is good or bad and whether defects are present or absent (at step S3). Alternatively, an optical image is obtained from the pattern drawn on the reticle (at step S1). Then, create a reference image from the design data of the reticle (at step S2). This is called the reference image creation step. Data of the resulting optical image and reference image (i.e., input data at input nodes a and b) are then compared together by the common comparison technique, which is called the common comparison step. By this comparison, there are determined whether the pattern is good or bad and whether defects are found or not (at step S3). If more than one defect is found at this decision step, then determine this reticle to be a defective product (at step S4).

In case no defects are found, a feature comparison technique is used to perform more accurate image inspection. The feature comparison technique is such that a plurality of comparison schemes are provided in accordance with pattern features. Let these comparison schemes be a feature comparison scheme 1, a feature comparison scheme 2, . . . , a feature comparison scheme n. Each feature comparison scheme is associated with feature data indicative of a specific kind of preset reticle pattern feature. When performing image comparison, in an image being tested, refer to the feature data (at step S5); then, select one from among the feature comparison schemes (at select step S6); next, perform image comparison using the selected feature comparison scheme (at feature comparison step S7, S8, S9). When defects are found by any one of the feature comparison schemes, this reticle is determined to be defective (at step S10). Alternatively, in case an affirmative inspection result is obtained by any one of the feature comparison schemes, the reticle is handled as a defect-free product (at step S10). Using this comparison technique makes it possible to achieve adequate and highly accurate pattern inspection in accordance with the pattern feature of interest. In addition, it becomes possible to adjust the length of inspection time period in such a way that a sufficient testing time is reserved for necessary patterns only while saving time for inspection of immaterial patterns that are less in importance. This makes it possible to increase the efficiency of pattern inspection, thereby enabling cut-down of the pattern inspection time as a whole.

Although in FIG. 4 the good/bad judgment (at step S3) using the common comparison technique is performed prior to the selection of an optimal feature comparison scheme (at step S6), various combinations of the common comparison and feature comparison techniques are available. An example is that the good/bad judgment using the common comparison and feature comparison techniques may be done after completion of the optimal feature comparison scheme selection (S6). In such case, the sole common comparison process may be laid out in parallel to a comparison process with a combination of common and feature comparison methods. At this time, a certain comparison method is to be selected at the step of optimal comparison scheme selection (S6), which method is a combination of the common comparison method and a comparison method of the combined common and feature comparison methods. Another exemplary approach is to arrange the common comparison process and feature comparison process so that these are in parallel with each other. In this case, the common and feature comparison methods are to be selected at the step of optimal comparison scheme selection (S6).

(Reticle Inspected)

A reticle is pattern-formed by lithography equipment using design data. The reticle prepared is then subjected to optical image inspection by the pattern inspection apparatus stated supra. In this event, pattern inspection is carried out through comparison of an optical image and a reference image. This comparison method is performed by feature comparison taking account of feature data, whereby comparison with the weighting of such feature data being considered is carried out. As a result, it is possible to obtain the intended reticle having a more accurate pattern image. Optionally, during the comparison of optical and reference images, the feature comparison and the common comparison may be combined together.

### EXAMPLE 1

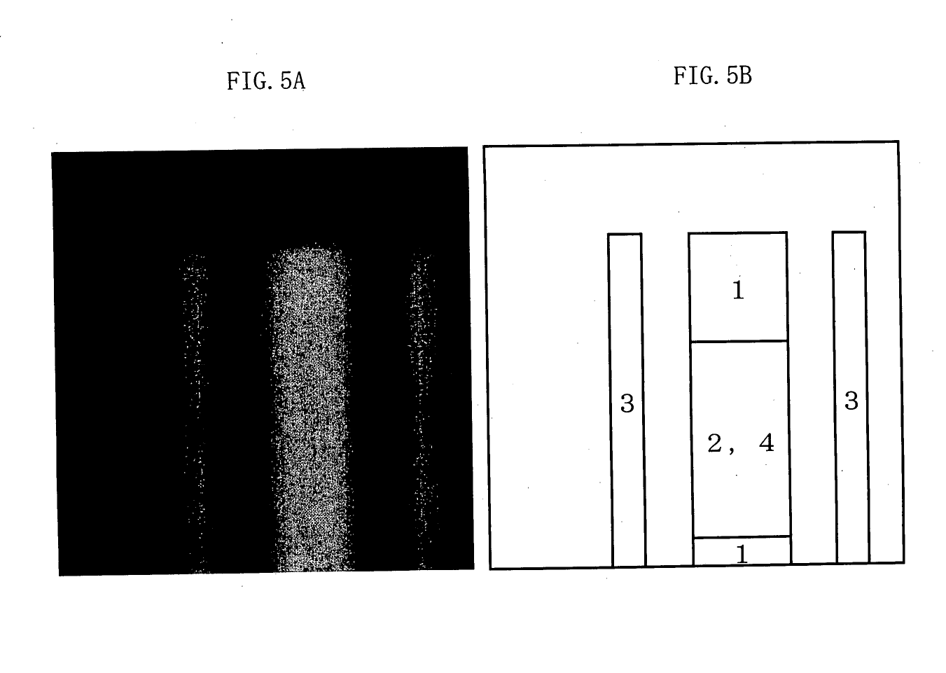

A pattern featuring a reticle image is shown in FIG. 5A. Feature data corresponding to such pattern is shown in FIG. 5B. The feature data of FIG. 5B indicates pattern features by numerals “1” to “4.” The feature data should not exclusively be limited to numerals and may be any ones as far as they offer pattern distinguishabilities, such as characters, symbols, etc. A pattern feature data item 1 shown in FIG. 5 is an indication part that instructs execution of the common comparison technique, which is an ordinary or standard comparison method. A feature data item 2 is an indicator which instructs the common comparison technique and a feature comparison scheme for detailed or precise comparison of pattern line widths. A feature data item 3 is an indicator which instructs the common comparison technique and a feature comparison scheme for precise comparison of relative positions of adjacent patterns. A feature data item 4 is an indicator that instructs the common comparison technique and a feature comparison scheme for precise comparison of edge roughness.

In the case of comparison between reticle optical images or alternatively comparison between an optical image and a reference image, when the above-noted feature data is given to a reticle under inspection, the reticle's image is inspected in accordance with the system procedure shown in the flow diagram of FIG. 4. Firstly, after having acquired an optical image (at step S1) and created a reference image (at step S2), inspect the reticle for defects using the common comparison technique (step S3). Then, let the system routine branch out in responding to whether defects are found or not (step S4). If no defects are found then refer to the feature data of FIG. 5B (step S5). Next, select an optimal feature comparison scheme based on the pattern to be compared and the feature data (at step S6), followed by further reticle inspection using the selected feature comparison scheme (at step S7, S8 or S9) and then diverge the system routine in reply to a test result as to whether defects are present or absent (at step S10). Alternatively, it is permissible to eliminate the common comparison-based judgment (S3) and defect judgment (S4) in the flowchart of FIG. 4 and to cause the procedure to start with the feature data referencing step (S5) after having acquired an optical image (S1) and created a reference image (S2). If this is the case, the common comparison-based good/bad judgment (S3) is performed after having referred to the feature data (S5), followed by selection of a feature comparison scheme at the optimal comparison scheme selection step (S6), thereby to perform good/bad judgment by the selected feature comparison scheme (at step S7, S8, S9).

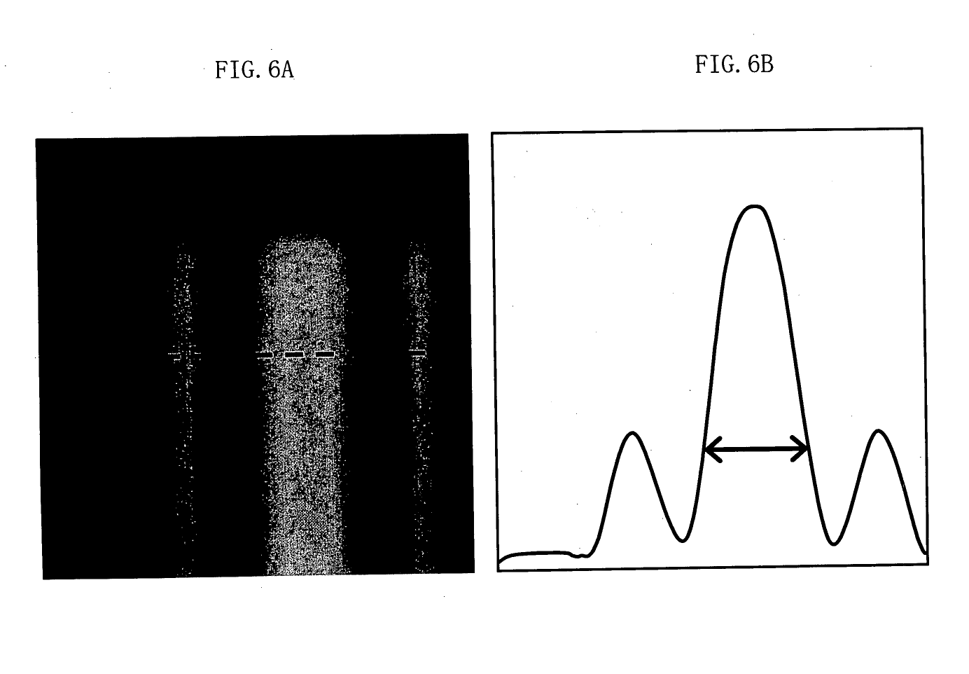

Pattern linewidth comparison means and method of the feature data 2 are implemented as shown in FIGS. 6A-6B. In a cross-section indicated by broken line of FIG. 6A, the profile of a gray-scale or “tone” value of FIG. 6B is obtained. Let a width of this profile be defined as the pattern linewidth; then, perform image comparison. By doing comparison after obtainment of the pattern linewidth in this way, it becomes possible to achieve more accurate pattern comparison relating to the linewidth.

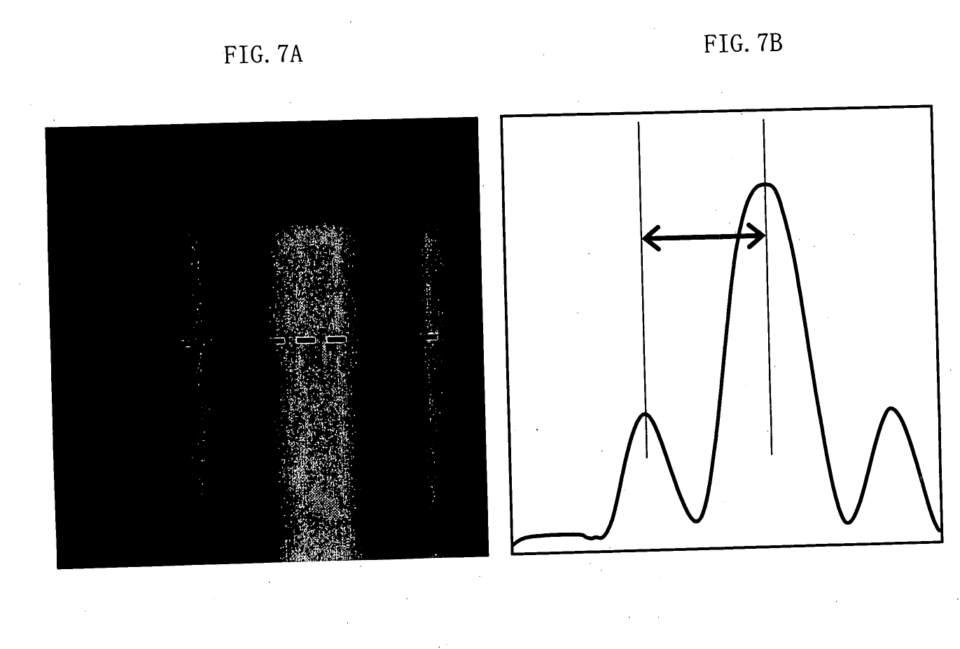

Comparison of relative positions of neighboring pattern segments of the feature data 3 is as follows. Obtain a profile of tone value of FIG. 7B in a cross-section indicated by dotted line in FIG. 7A. Then, identify a peak value of the pattern segment of interest in this profile. Also identify a peak value of its neighboring pattern segment in the profile. Next, obtain a distance between these pattern peaks for comparison. Thus it becomes possible to achieve more accurate comparison of the relative positions of such adjacent pattern segments.

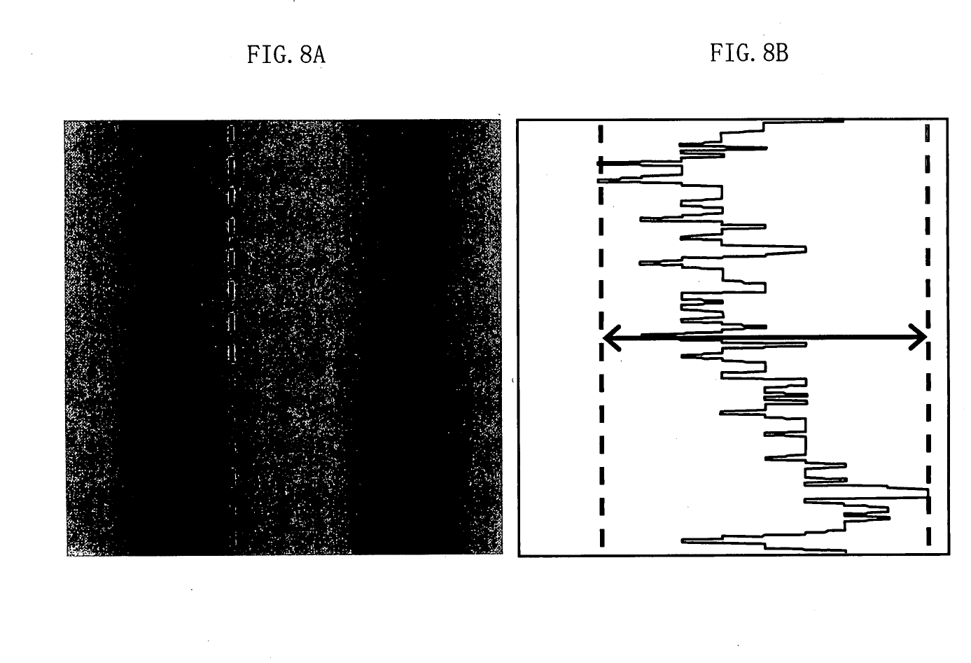

Regarding comparison of the edge roughness of the feature data 4, in a cross-section indicated by broken line in FIG. 8A, obtain a profile of tone value of FIG. 8B. Find a difference or “discrepancy” between maximal and minimal values of the profile within a specified zone and then define it as an edge roughness. By comparing this difference, it becomes possible to accomplish more accurate pattern edge roughness comparison.

### EXAMPLE 2

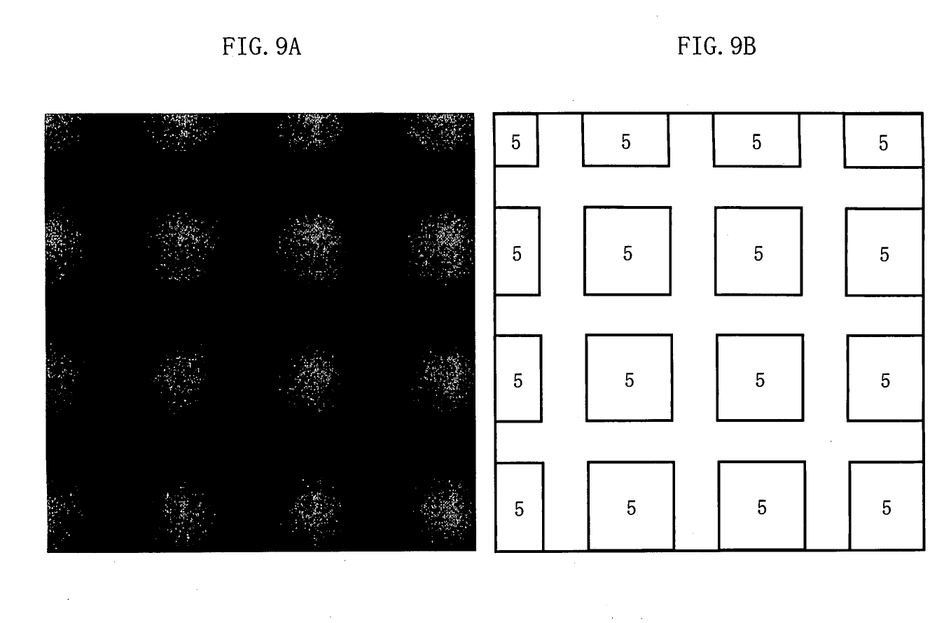

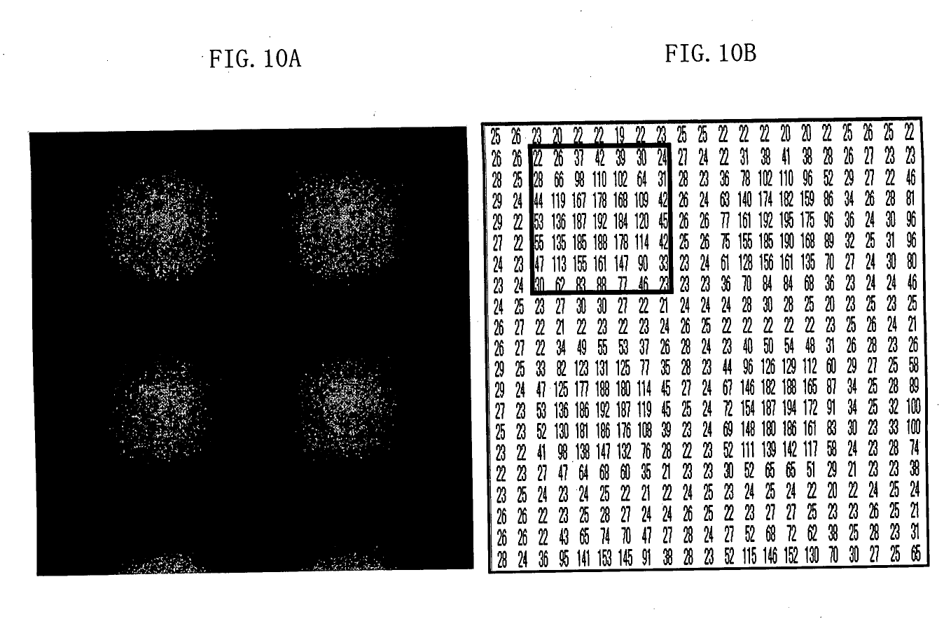

See FIG. 9A, which shows a specific pattern of holes. A group of feature data corresponding to this hole pattern is shown in FIG. 9B. Feature data items 5 are indicator parts which prescribe a common comparison technique and a feature comparison scheme for precise comparison of an amount of light that passed through the pattern. Comparison of the thru-the-pattern transmitted light amount of the feature data 5 is carried out in a way shown in FIGS. 10A-10B. In a distribution of pixel values of the holes of FIG. 10A, obtain a total sum of numeric values within a frame of FIG. 10B, and then compare it to a reference value. By obtaining for comparison the transmitted light amount of the holes of the pattern in this way, it becomes possible to achieve more accurate hole pattern comparison. Although several feature comparison schemes have been set forth in regard to some typical patterns, these patterns are illustrative of this invention. The principles of the invention are applicable to any given patterns.

Additional advantages and modifications will readily occur to those skilled in the art to which the invention pertains. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A pattern inspection apparatus comprising:
an optical image acquisition unit operative to obtain an optical image of an object being tested;
a plurality of types of feature comparison units operative to compare, based on feature data indicative of pattern features of the optical image of the test object, identical patterns at different positions on the test object; and
a selector unit operative to select, during comparison of the identical patterns of the optical image, a kind of feature comparison unit from the feature data of a pattern under inspection.

2. The apparatus according to claim 1, further comprising:
a common comparison unit serving as a common comparator means to all patterns, for comparison of identical patterns at different positions on the test object.

3. The apparatus according to claim 1, wherein said feature comparison units compare any one of a pattern line width, an amount of pattern transmitted light, roughness of a pattern edge, and a relative position of adjacent locations of the pattern.

4. A pattern inspection apparatus comprising:
an optical image acquisition unit operative to obtain an optical image of an object being tested;
a reference image creation unit operative to make a reference image from design data of a pattern of the test object;
a plurality of types of feature comparison units operative to compare, based on feature data indicative of pattern features of the test object, the optical image to the reference image; and
a selector unit operative to select, when comparing
between the optical image and the reference image, a kind of feature comparison unit from the feature data of a pattern to be inspected.

5. The apparatus according to claim 4, further comprising:
a common comparison unit for use as a common comparator means to all patterns, for comparison of an optical image and a reference image.

6. The apparatus according to claim 4, wherein said feature comparison units compare any one of a pattern line width, an amount of pattern transmitted light, roughness of a pattern edge, and a relative position of adjacent locations of the pattern.

7. A pattern inspection method comprising:
an optical image acquisition step of obtaining an optical image of an object being tested;
a plurality of kinds of feature comparison steps of comparing, based on feature data indicative of pattern features of the test object, identical patterns at different positions on the test object; and
a selection step of selecting, when comparing an optical image and a reference image, a feature comparison step from the feature data of a pattern under inspection.

8. The method according to claim 7, further comprising: a common comparison step applicable in common to all patterns, for comparing identical patterns at different positions on the test object.

9. The method according to claim 7, wherein the feature comparison steps include comparing any one of a pattern linewidth, an amount of pattern transmitted light, roughness of a pattern edge and a relative position of adjacent locations of the pattern.

10. A pattern inspection method comprising:
an optical image acquisition step of acquiring an optical image of an object being tested;
a reference image creation step of making a reference image from design data of a pattern of the test object;
a plurality of kinds of feature comparison steps of comparing, based on feature data indicative of pattern features of the test object, the optical image to the reference image; and
a selection step of selecting, when comparing the optical image to the reference image, a feature comparison step from the feature data of a pattern under inspection.

11. The method according to claim 10, further comprising:
a common comparison step for comparison of an optical image to a reference image in a way commonized to all patterns.

12. The method according to claim 10, wherein the feature comparison steps include comparing any one of a pattern linewidth, an amount of pattern transmitted light, roughness of a pattern edge and a relative position of adjacent locations of the pattern.

13. A pattern inspection method comprising: storing in advance a plurality of kinds of feature comparison schemes adaptable for comparison of a plurality of different types of pattern features;
obtaining an optical image of an object being tested and having a pattern;
upon receipt of feature data indicative of a feature of the pattern of the test object, using the data to select from among said schemes at least one feature comparison scheme applicable to said test object; and
using the selected feature comparison scheme to compare identical pattern portions at different locations on said test object to thereby inspect said test object for defects.

14. The method of claim 13 further comprising: comparing said identical pattern portions by a common comparison technique applicable in common to all of a collection of predefined patterns.

15. A pattern inspection method comprising: prestoring a plurality of kinds of feature comparison schemes applicable respectively to a plurality of prespecified types of pattern features;
obtaining an optical image of an object being tested and having a pattern;
receiving design data of the pattern of the test object to make a reference image;
receiving feature data indicative of a feature of the test object pattern to select, based on said feature data, at least one feature comparison scheme to be applied to said
test object from among said feature comparison schemes; and using the selected feature comparison scheme to compare said optical image to said reference image to thereby inspect said test object for defects.

16. The method of claim 15 further comprising: comparing said optical image to said reference image by a common comparison technique employable in common to all of a collection of predefined patterns.

17. The method of claim 15 wherein said pattern features include a pattern line width, an amount of pattern-transmitted light, a pattern edge roughness, and relative positions of adjacent pattern portions.

18. A reticle with pattern inspection applied thereto by common comparison of optical images with respect to identical patterns at different positions on the reticle and with further pattern inspection being applied to the reticle
by a plurality of kinds of optical image feature comparisons based on feature data indicative of reticle pattern features concerning identical patterns at different positions on said reticle.

19. A reticle with pattern inspection applied thereto by common comparison of an optical image of the reticle to a reference image and with further pattern inspection being applied to said reticle by a plurality of kinds of feature comparisons of optical and reference images based on feature data indicative of reticle pattern features.
